(19) United States
(12) Patent Application Publication
(10) Pub. No.: US 2009/0123775 A1
(43) Pub. Date: May 14, 2009

(54) Method for producing Cr containing nickel-base alloy tube and Cr containing nickel-base alloy tube

(76) Inventors: Manabu Kanzaki, Amagasaki-shi (JP); Kazuyuki Kitamura, Kobe-shi (JP); Noriaki Hirohata, Osaka-shi (JP)

Correspondence Address: CLARK & BRODY, 1090 VERMONT AVENUE, NW, SUITE 250, WASHINGTON, DC, 20005, US

(21) Appl. No.: 12/285,644

(22) Filed: Oct. 10, 2008

Related U.S. Application Data
(63) Continuation of application No. PCT/JP2007/057833, filed on Apr. 9, 2007.

(30) Foreign Application Priority Data
Apr. 12, 2006 (JP) 2006-109629

(51) Int. Cl. B29D 23/00; B05D 7/22; B32B 1/08

(52) U.S. Cl. 428/586; 427/237

(57) ABSTRACT

To form a chromium oxide film on the inner surface of a Cr containing nickel-base alloy tube inexpensively and uniformly, the Cr containing nickel-base alloy tube is heated in atmospheric gas of carbon dioxide gas and non-oxidation gas to form an oxide film consisting of chromium oxide having a thickness of 0.2 to 1.5 μm on the inner surface of the Cr containing nickel-base alloy tube. The atmospheric gas may contain oxygen gas of 5 vol % or less and/or water vapor of 7.5 vol % or less.

The disclosure of International Application No. PCT/JP2007/057833 filed Nov. 15, 2007 including specification, drawings and claims is incorporated herein by reference in its entirety.

### TECHNICAL FIELD

The present invention relates to a method for producing a Cr containing nickel-base alloy tube and pipe (hereinafter tube) and a Cr containing nickel-base alloy tube that minimize release of nickel when used in high-temperature water for a long period of time. In particular, the invention relates to a Cr containing nickel-base alloy tube suitable for applications such as members for an nuclear power plant.

### BACKGROUND ART

Since nickel-base alloys are excellent in mechanical properties, they have been used for the material of various members. In particular, the Ni-base alloys have been used for nuclear reactors, since when they are exposed to high temperature water, they have excellent corrosion resistance. For example, as a material for a steam generator in the pressurized water reactor (PWR), an alloy of 60% Ni, 30% Cr, and 10% Fe is used.

These members are used in high temperature water of about 300° C., which is the environment of the reactor water, for several years to several ten years. Although a nickel-base alloy is excellent in corrosion resistance and has a small corrosion rate, a very small amount of Ni may be released from the base material through a long period of service.

The released Ni is carried to the core of the reactor in the circulating process of the reactor water and is irradiated with neutrons in the vicinity of nuclear fuel. When Ni is subjected to the neutron irradiation, it is converted to radioactive Co by a nuclear reaction. Since radioactive Co has a very long half-life, it continues to emit radiation for a long period of time. Therefore, when the amount of released Ni is large, the dosage of radiation to workers, who carry out periodical inspections and the like, increases.

It is very important to reduce the dosage of radiation when using the light water reactor for a long period of time. Therefore, some measures to prevent the Ni release from the nickel-base alloy, such as an improvement of corrosion resistance of the alloy and controlling the water quality in the nuclear reactor have been adopted.

Patent document 1 discloses a method of improving general corrosion resistance by annealing a heat exchanger tube of nickel-base alloy in an atmosphere of a vacuum degree of 10⁻² to 10⁻⁴ Torr, at a temperature range of 400 to 750° C., in order to form an oxide film mainly consisting of chromium oxide.

Patent document 2 discloses a method for producing a member for an nuclear power plant by, after solution heat treatment of a nickel-base precipitation reinforced alloy, conducting heat treatment in an oxidized atmosphere of 10⁻³ Torr to atmospheric air as part of at least age-hardening treatment and oxide film-forming treatment.

Patent document 3 discloses a method for producing a nickel-base alloy product by heat treating a nickel-base alloy product in hydrogen or a mixed atmosphere of hydrogen and argon with a dew point of −60 to +20° C.

Patent document 4 discloses a method for forming a chromium-enriched layer by exposing an alloy work piece containing Ni and Cr to a gas mixture of water vapor and at least one non-oxidative gas.

Patent document 5 discloses a method of heat treatment for an efficient forming of two-layered oxide film on the inside surface of a Ni-base alloy tube, the oxide film suppressing the Ni release in a high-temperature water environment. At least two gas supplying devices are provided on the outlet side of a continuous heat treatment furnace; or one gas supplying device is provided respectively on the outlet side and the inlet side thereof. The tube is fed into the furnace while supplying an atmospheric gas into the tube from the front end of the tube moving direction with the use of one of these gas supplying devices and a gas feeding pipe, which is arranged inside the furnace, and this tube is maintained at 650 to 1200° C. for 1 to 1200 minutes. The atmospheric gas consists of hydrogen or a mixture of hydrogen and argon, whose dew point is in a range of from −60 to +20° C. After the front end of the Ni-base alloy tube reaches the outlet side of the furnace, the supplier of atmospheric gas into the tube is switched to the other gas supplying device. The operations are repeated.
[Patent document 1] S 64-55366 A
[Patent document 2] H 8-29571 A
[Patent document 3] 2002-121630 A
[Patent document 4] 2002-322553 A
[Patent document 5] 2003-239060 A

### DISCLOSURE OF THE INVENTION

### Problems to be Solved by the Invention

The film formed by the method disclosed in patent document 1 is insufficient in thickness, and so the film could be worn through a long period of service and the release prevention effect could be lost.

In the method disclosed in patent document 2, oxidized Ni is easily incorporated in the film so that the Ni could be released during service.

With the method involving formation of an oxide film by controlling the amount of water vapor (dew point), like patent documents 3 and 4, and the heat treatment method using hydrogen gas or a mixed gas of hydrogen and argon whose dew point is controlled as atmospheric gas, like patent document 5, it is difficult to form a uniform oxide film at the inlet side and outlet side of water vapor. This is because of the following reasons.

For example, in the case of continuous treatment such as for an oxide film of a lengthy tube, the thickness of the formed oxide film is rate-controlled not only by oxygen potential but also by the diffusibility of the oxidation gas over the surface of the treated material through a concentration boundary layer. As used herein, the concentration boundary layer means a boundary layer of gas concentration distribution between the surface of the treated material and a place away from the surface (for example, in the vicinity of the central axis inside a tube). The diffusibility is influenced by physical properties such as a disperse coefficient of gas and a kinematic viscosity coefficient, and oxidation treatment conditions such as the concentration of gas and flow rate. Since water vapor (H₂O) is large in diffusibility compared with other oxidation gases such as carbon dioxide, when oxidation treatment is conducted under an atmosphere without oxidation gas except water vapor, then it becomes difficult to form a uniform oxide film at the inlet side and outlet side of water vapor.

When the thickness of the oxide film is too thin, the Ni release resistance effect cannot be obtained, whereas with too large a thickness, detachment tends to occur and thus the Ni release resistance deteriorates. A study conducted by the present inventors reveals that the thickness of the oxide film should be adjusted in a range of from micron order to submicron order.

For example, controlling the concentration of the oxidation gas makes it possible to adjust the composition in the oxide film formed on the inner surface of a tube. However, this method cannot enable adjustment of the thickness of the oxide film. On the other hand, the thickness of the film can be adjusted by controlling heat treatment conditions such as heating temperature and time, but a fine adjustment is difficult even by this method. Further, in the case of heat treatment including other purposes such as annealing, it is difficult to change these heat treatment conditions from the viewpoint of thickness of the oxide film.

The present inventors conducted an extensive study that has found that it is possible to control the thickness of the oxide film by controlling a relation between the concentration of oxidation gas and the flow rate of atmospheric gas. The present invention has been completed based on this knowledge.

The objective of the present invention is to provide a method for producing an inexpensive Cr containing nickel-base alloy tube having a chromium oxide uniformly formed on the surface of a Cr containing nickel-base alloy tube, and to provide such Cr containing nickel-base alloy tube.

### MEANS TO SOLVE THE PROBLEMS

The gist of the present invention is a method for producing a Cr containing nickel-base alloy tube described in (A) to (G) below, and a Cr containing nickel-base alloy tube described in (H) below.

(A) A method for producing a Cr containing nickel-base alloy tube, characterized by forming an oxide film consisting of chromium oxide having a thickness of 0.2 to 1.5 μm on the inner surface of the Cr containing nickel-base alloy tube by heating the Cr containing nickel-base alloy tube in an atmospheric gas of carbon dioxide gas and non-oxidation gas.

(B) The method for producing a Cr containing nickel-base alloy tube described in (A), characterized in that the atmospheric gas contains oxygen gas of 5 vol % or less and/or water vapor of 7.5 vol % or less.

(C) The method for producing a Cr containing nickel-base alloy tube described in (A) or (B), characterized by controlling the concentration of the oxidation gas and the flow rate of the atmospheric gas into the Cr containing nickel-base alloy tube.

(D) The method for producing a Cr containing nickel-base alloy tube described in (C), characterized by feeding the atmospheric gas into the Cr containing nickel-base alloy tube while satisfying a relation specified by the following formula (1):

0.5≦C×Q^{1/2}≦7.0 (1)

where:

C denotes concentration of the oxidation gas (vol %); and

Q denotes flow rate of the atmospheric gas (l/minute).

(E) The method for producing a Cr containing nickel-base alloy tube described in any one of (A) to (D), characterized by forming a chromium oxide film, satisfying a relation specified by the following formula (2), on the inner surface of the Cr containing nickel-base alloy tube.

|t1−t2|≦0.5 μm (2)

where t1 and t2 denote thickness (μm) of the chromium oxide film at both ends of the tube.

(F) The method for producing a Cr containing nickel-base alloy tube described in any one of (A) to (E), characterized by using a continuous heat treatment furnace, a gas feeding tube penetrating the furnace, and a gas supplying device movable in the tube feeding direction, and forming a chromium oxide film on the inner surface of the tube in the following steps:

(1) supplying an atmospheric gas from the front end of the tube toward the rear end thereof, before feeding the tube into the continuous heat treatment furnace, while the atmospheric gas is supplied from the outlet side of the furnace by the gas supplying device through the gas feeding tube;

(2) feeding the tube into the continuous heat treatment furnace while supplying the atmospheric gas from the front end of the tube toward the rear end thereof, and

(3) replacing the gas supplying device, after the front end of the tube reaches the outlet side of a heating zone of the continuous heat treatment furnace.

(G) The method for producing a Cr containing nickel-base alloy tube described in any one of (A) to (E), characterized by using a continuous heat treatment furnace, a gas feeding tube penetrating the furnace, and a gas supplying device movable in the tube feeding direction, and forming a chromium oxide film on the inner surface of the tube in the following steps:

(1) supplying an atmospheric gas from the front end of the tube toward the rear end thereof, before feeding the tube into the continuous heat treatment furnace, while the atmospheric gas is supplied from the inlet side of the furnace by the gas supplying device through the gas feeding tube;

(2) feeding the tube into the continuous heat treatment furnace while supplying the atmospheric gas from the front end of the tube toward the rear end thereof; and

(3) replacing the gas supplying device from the outlet side of the furnace, after the front end of the tube reaches the outlet side of a heating zone of the continuous heat treatment furnace.

(H) A Cr containing nickel-base alloy tube, characterized by forming a chromium oxide film having a thickness of 0.2 to 1.5 μm and satisfying a relation specified by the following formula (2), on the inner surface of the Cr containing nickel-base alloy tube.

|t1−t2|≦0.5 μm (2)

where t1 and t2 denote thickness (μm) of the chromium oxide film at both ends of the tube.

The Cr containing nickel-base alloy tube preferably contains, by mass %, C: 0.15% or less, Si: 1.00% or less, Mn: 2.0% or less, P: 0.030% or less, S:

0.030% or less, Cr: 10.0 to 40.0%, Fe: 15.0% or less, Ti: 0.5% or less, Cu: 0.50% or less, and Al: 2.00% or less, with the balance being Ni and impurity. It may also contain, at least one element selected from the following groups:

group 1: Nb and/or Ta: 3.15 to 4.15% by mass in total; and

group 2: Mo: 8 to 10% by mass.

The Cr containing nickel-base alloy tube may be used, for example, as a member for an nuclear power plant.

As used herein, the “chromium oxide film” means an oxide film consisting mainly of Cr₂O₃, and may contain an oxide other than Cr₂O₃, for example, MnCr₂O₄, TiO₂, Al₂O₃, and SiO₂. Insofar as the Cr containing nickel-base alloy has on its surface an oxide film consisting of chromium oxide, some other oxide layer may be formed on an upper layer (outside layer) and/or a lower layer (inside layer) of the chromium oxide film.

### Effects of the Invention

According to the present invention, a chromium oxide film can be formed on the inner surface of the Cr containing nickel-base alloy tube inexpensively and uniformly. The Cr containing nickel-base alloy tube produced by the method of the present invention minimizes release of Ni even when used in high-temperature water in an nuclear power generation plant for a long period of time, and therefore finds applications in members used in high temperature water such as steam generator tubing, and in particular, in a member for an nuclear power plant.

### BEST MODE FOR CARRYING OUT THE INVENTION

1. Atmospheric Gas Supplied into the Tube

In the method for producing a Cr containing nickel-base alloy tube according to the present invention, the most important feature is that a chromium oxide film is formed on the inner surface of the Cr containing nickel-base alloy tube by heating the Cr containing nickel-base alloy tube with atmospheric gas of carbon dioxide gas and non-oxidation gas, and atmospheric gas containing oxygen gas of 5 vol % or less and/or water vapor of 7.5 vol % or less.

Since only a slight content of carbon dioxide suffices in forming a chromium oxide, the lower limit is not particularly specified. Yet the desired effect is remarkable at a content of 0.0001 vol % or more. The upper limit of the concentration of the carbon dioxide gas is not particularly limited, but from the viewpoint of reducing production costs, it is preferably 50 vol % or less, and further preferably 10 vol % or less.

Carbon dioxide gas has the effect of forming a chromium oxide film on the inner surface of a Cr containing nickel-base alloy tube in high temperature. Namely, under an atmosphere of carbon dioxide gas, as shown in the following reaction formula, CO₂ is adsorbed on a Cr containing nickel-base alloy tube (M), and from CO₂, O (oxygen) is directly taken in the Ni-base alloy, thereby to form a chromium oxide:

CO₂+M→CO+MO

Since the diffusibility of carbon dioxide is less than that of water vapor, the thickness of the formed chromium oxide film is hardly influenced by oxidation treatment conditions such as concentration of the supplied gas and flow rate. Therefore, it is possible to form an oxide film on the inner surface of the tube more uniformly than oxidation treatment conducted in the conventional water vapor atmosphere. As an advantage for using carbon dioxide gas, a desired oxidation treatment atmosphere can be prepared more inexpensively than the method that controlled the moisture content by a conventional dew point generator.

Oxygen gas forms chromium oxide in the same manner as carbon dioxide gas, and so it may be contained in the atmospheric gas in lieu of part of the carbon dioxide gas. However, if a large amount of oxygen gas is contained, formation of the chromium oxide film is promoted to lower the Cr concentration in the base material, thereby deteriorating corrosion resistance. Hence, when oxygen gas is contained, its concentration is preferably set to 5 vol % or less. Only a slight amount of the oxygen gas suffices in obtaining the aforementioned effect, and so the lower limit is not particularly specified. Yet the effect becomes remarkable when 0.0001 vol % or more is contained.

Water vapor forms chromium oxide in the same manner as carbon dioxide gas, and so it may be contained in the atmospheric gas. However, when a large amount of water vapor is contained, oxidation of Ni tends to occur and concentration of Ni in the film increases, creating a possibility of Ni release in the environment that is being used. Hence, when water vapor is contained, its concentration is preferably set to 7.5 vol % or less. The upper limit is more preferably 2.5 vol %. On the other hand, the lower limit of the water vapor is not particularly limited, but it is preferably 0.01 vol % or more for sufficiently forming a chromium oxide film that is effective to suppression of Ni release. The lower limit is more preferably 0.1 vol %.

Thus, in the present invention, atmospheric gas of carbon dioxide gas and non-oxidation gas, or atmospheric gas containing oxygen gas of 5 vol % or less and/or water vapor of 7.5 vol % or less is supplied to conduct oxidation treatment of the inner surface of the Cr containing nickel-base alloy tube.

Examples of the non-oxidation gas include hydrogen gas, rare gas (Ar, He, and the like), carbon monoxide gas, nitrogen gas, and hydrocarbon gas. Of these non-oxidation gases, when using carbon monoxide gas, nitrogen gas or hydrocarbon gas, it is preferable to additionally contain at least one of hydrogen gas and rare gas because there is a fear of carburization and nitridation. By adjusting the gas concentration of these non-oxidation gases, the concentration of carbon dioxide gas, or further oxygen gas and/or water vapor can be suitably adjusted.

Additionally, hydrogen gas is often used industrially as atmospheric gas in heat treatment, and using this as dilution of the carbon dioxide gas can lower production costs. Hence, it is most preferable to conduct heat treatment with a gas environment of carbon dioxide gas and hydrogen gas as the atmospheric gas.

The concentration of the atmospheric gas when containing water vapor can be controlled by, after adjusting the concentration of the carbon dioxide gas and the non-oxidation gas, or further oxygen gas, controlling the concentration of water vapor through dew point control. After adjusting the dew point using the non-oxidation gas, the carbon dioxide gas or further oxygen gas may also be added.

When the oxygen gas is mixed with hydrogen gas or hydrocarbon gas as the atmospheric gas, consideration must be taken not to cause explosion. For this purpose, when hydrogen gas or hydrocarbon gas is used, heat treatment is conducted under a mixed gas atmosphere of carbon dioxide gas and non-oxidation gas, or further water vapor.

2. Thickness of the Film Formed on the Inner Surface of the Tube

Since the Ni release resistance depends on the thickness of the film, the thickness of the film needs to be controlled. A film thickness of less than 0.2 μm is insufficient for the Ni release resistance. From the examination of a relation between the thickness of the film and Ni release amount by a release test, the effect of suppressing Ni release is observed in 0.2 μm or more, and Ni release resistance further improves when the thickness of the film is 0.3 μm or more.

However, the thicker the thickness of the film is, detachment tends to occur, and detachment of the film becomes noticeable when the thickness exceeds 1.5 μm. The upper limit of the thickness of the film is preferably set to 0.95 μm, and more preferably 0.8 μm.

3. Flow Rate of the Atmospheric Gas Supplied to the Inner Surface of the Tube

To oxidize only the Cr present on the inner surface of a tube, the interior of the tube needs to be rendered a low oxygen potential environment. Under such environment, it is believed that supply of the oxidation gas controls the speed of the oxidation reaction. On the other hand, a concentration gradient takes place when the atmospheric gas is supplied inside the tube, and the diffusibility of gas here is believed to be dependent on concentration of the oxidation gas and flow rate of the atmospheric gas. Since supply of the oxidation gas depends on the diffusibility of gas, it also is believed to be dependent on concentration of the oxidation gas and flow rate of the atmospheric gas as well.

Then, the present inventors have done various tests from such viewpoints, and found that the chromium oxide film formed on the inner surface of the tube can be made to a desired thickness by supplying atmospheric gas while satisfying a relation specified by the following formula (1):

0.5≦C×Q^{1/2}≦7.0 (1)

where:

C denotes concentration of the oxidation gas (vol %); and

Q denotes flow rate of the atmospheric gas (1/minute).

The lower limit of the above formula (1) is preferably 1.0 and the upper limit is preferably 4.0.

4. Heat Treatment Temperature and Heat Treatment Time

While the heat treatment temperature and heat treatment time are not particularly limited, for example, the heating temperature can be in a range of 500 to 1250° C. and the heating time can be in a range of 10 seconds to 35 hours. The respective limiting reasons are as follows.

Heating temperature: 500 to 1250° C.

The heating temperature may be a range in which the thickness and composition of the oxide film and the strength property of the alloy are suitable. Specifically, when the heating is less than 500° C., there is a case in which oxidation of chromium is insufficient, and in more than 1250° C., there is a fear that strength of the Cr containing nickel-base alloy material cannot be ensured. Therefore, the heating temperature is preferably set in a range of 500 to 1250° C.

Heating time: 10 seconds to 35 hours

The heating time may be set in a range in which the thickness and composition of the oxide film are suitable. That is, to form an oxide film consisting mainly of chromium oxide, it is preferable to heat for 10 seconds or more. After heating over 35 hours, the oxide film is not substantially generated. Therefore, the heating time is preferably set in a range of 10 seconds to 35 hours.

Additionally, in the case of conducting the film-forming treatment by a continuous heat treatment furnace, it is necessary to improve productivity by shortening the heating time. Since the higher the heating temperature, the shorter the heating time is possible, when the heating temperature is set in a range of 1000 to 1200° C., the film with the thickness of the present invention can be formed by setting a heating time in a range of 10 seconds to 60 minutes, further preferably in a range of 1 to 20 minutes.

5. Variation of the Thickness of the Film

If the thickness of the film varies largely in the longitudinal direction of the tube and the thickness of the film is locally formed, then the amount of released Ni increases in that part. Hence, variation of thickness of the film is preferably small. Namely, the thickness of the film preferably satisfies a relation specified by the following formula (2).

|t1−t2|≦0.5 μm (2)

where t1 and t2 denote thickness (μm) of the chromium oxide film at both ends of the tube.

The right side of the formula (2) is preferably set to 0.3 μm.

Variation of the thickness of the film is large with mixed gas of water vapor having large diffusibility and a non-oxidation gas as the atmospheric gas. Hence, in the present invention, mixed gas of carbon dioxide gas having small diffusibility and a non-oxidation gas or a mixed gas further with some other oxidation gas is used. This minimizes variation of the thickness of the film.

In the film-forming treatment of the Ni-based alloy tube, heat treatment is conducted the tube with a shipping length as a product. In view of this, after conducting the heat treatment, test pieces are cut from both ends of the tube and measured for the thickness of the film.

4. Chemical Composition of the Tube of the Cr Containing Nickel-Base Alloy

As the chemical composition of the tube of the Cr containing nickel-base alloy related to the production method of the present invention, for example, it preferably contains, by mass %, C: 0.15% or less, Si: 1.00% or less, Mn: 2.0% or less, P: 0.030% or less, S: 0.030% or less, Cr: 10.0 to 40.0%, Fe: 15.0% or less, Ti: 0.5% or less, Cu: 0.50% or less, and Al: 2.00% or less, with the balance being Ni and impurity. The limiting reason for each element is as follows. The symbol “%” for the content in the following explanation means “mass percent”.

C: 0.15% or less

When C is more than 0.15% in content, there is a fear that stress corrosion cracking resistance deteriorates. Hence, when C is contained, the content is preferably 0.15% or less. It is further preferably 0.06% or less. Additionally, C has the effect of enhancing the grain boundary strength of the alloy. To obtain this effect, the C content is preferably 0.01% or more.

Si: 1.00% or less

Si is used as a deoxidizer in smelting, and remains in the alloy as an impurity. In this case, the content may be limited to 1.00% or less. When the content exceeds 0.50%, the purity of the alloy may deteriorate, and so the Si content is preferably limited to 0.50% or less.

Mn: 2.0% or less

In excess of 2.0%, Mn lowers the corrosion resistance of the alloy, and so it is preferably set to 2.0% or less. Mn is low in free energy of formation of oxide compared with Cr, and precipitates as MnCr₂O₄ by heating. Also since Mn is relatively fast in disperse speed, first Cr₂O₃ generally forms by heating in the vicinity of the base material, and outside Cr₂O₃, MnCr₂O₄ forms as an upper layer. When the MnCr₂O₄ layer exists, the Cr₂O₃ layer is protected in the use environment, and even when the Cr₂O₃ layer is destroyed for some reason, MnCr₂O₄ promotes restoration of Cr₂O₃. Such effect becomes noticeable when the Mn content is 0.1% or more. Therefore, a preferable Mn content is 0.1 to 2.0%, and 0.1 to 1.0% is more preferable.

P: 0.030% or less

P is an element present in the alloy as an impurity. When the content exceeds 0.030%, corrosion resistance may be adversely influenced. Therefore, the P content is preferably limited to 0.030% or less.

S: 0.030% or less

S is an element present in the alloy as an impurity. When the content exceeds 0.030%, corrosion resistance may be adversely influenced. Therefore, the S content is preferably limited to 0.030% or less.

Cr: 10.0 to 40.0%

Cr is a necessary element for forming an oxide film consisting of chromium oxide. To form such oxide film on the surface of the alloy, Cr is preferably contained at 10.0% or more. However, in excess of 40.0%, the Ni content becomes relatively small, and there is a fear that the corrosion resistance of the alloy deteriorates. Therefore, the Cr content is preferably 10.0 to 40.0%. In particular, when Cr is contained at 14.0 to 17.0%, it is excellent in corrosion resistance in environments containing chloride, while when Cr is contained at 27.0 to 31.0%, it is further excellent in corrosion resistance under environments of pure water and alkaline at high temperatures.

Fe: 15.0% or less

When Fe exceeds 15.0%, there is a fear that the corrosion resistance of the Cr containing nickel-base alloy deteriorates. Therefore, the Fe content is set to 15.0% or less. Fe is an element usable in lieu of part of the expensive Ni by solid solution in Ni, and so it is preferably contained at 4.0% or more. The Fe content may be determined from the balance of Ni and Cr; preferably, when Cr is contained at 14.0 to 17.0%, Fe is set to 6.0 to 10.0%, while when Cr is contained at 27.0 to 31.0%, Fe is set to 7.0 to 11.0%.

Ti: 0.5% or less

There is a fear that Ti deteriorates the purity of an alloy when the content exceeds 0.5%, and so the Ti content is preferably set to 0.5% or less, further preferably 0.4% or less. However, from the viewpoint of improvement on workability of the alloy and suppression of grain growth in welding, a content of 0.1% or more is preferable.

Cu: 0.50% or less

Cu is an element present in the alloy as an impurity. When the content exceeds 0.50%, the corrosion resistance of the alloy may deteriorate. The Cu content is therefore preferably limited to 0.50% or less.

Al: 2.00% or less

Al is used as a deoxidizer in steelmaking, and remains in the alloy as an impurity. The remaining Al becomes an oxide-based inclusion in the alloy, which deteriorates the purity of the alloy, and there is a fear that it adversely influences the corrosion resistance and mechanical properties of the alloy. The Al content is therefore preferably limited to 2.00% or less.

The above-described Cr containing nickel-base alloy may contain the aforementioned elements with the balance being Ni and impurity, but for the purpose of improving performance such as corrosion resistance and strength, Nb, Ta, or Mo may be suitably added.

Nb and/or Ta: 3.15 to 4.15% by mass in total

Since Nb and Ta easily form carbide, they are effective for improving the strength of the alloy. Also they fix C in the alloy and thus provide the effects of suppressing lack of Cr of the grain boundary and improving the corrosion resistance of the grain boundary. Therefore, either one of these elements or both of them may be contained. The above effects become noticeable when the content of either one of the elements or the total content of the two elements is 3.15% or more.

However, when the content of Nb and/or Ta is excessive, there is a fear that hot workability and cold workability deteriorate and susceptibility to embrittlement by heat is enhanced. Hence, it is preferable that the content of a single element, in the case of containing either one of the elements, or the total content of the two elements, in the case of containing both elements, is 4.15% or less. Thus, it is preferable that the content of either one of Nb and Ta, in the case of containing either one of them, or the total content of Nb and Ta, in the case of containing both, is 3.15 to 4.15%.

Mo: 8 to 10%

Mo has the effect of improving pitting resistance, and may be contained as necessary. The above effect becomes noticeable at 8% or more. In excess of 10%, however, there is a fear that an intermetallic compound precipitates, which deteriorates corrosion resistance. Therefore, when Mo is contained, its content is preferably 8 to 10%.

Typical examples of the composition of the above-described tube of the Cr containing nickel-base alloy include the following two examples.

(a) A Cr containing nickel-base alloy containing C: 0.15% or less, Si: 1.00% or less, Mn: 2.0% or less, P: 0.030% or less, S: 0.030% or less, Cr: 14.0 to 17.0%, Fe: 6.0 to 10.0%, Ti: 0.5% or less, Cu: 0.50% or less, and Al: 2.00% or less, with the balance being Ni and impurity.

(b) A Cr containing nickel-base alloy containing C: 0.06% or less, Si: 1.00% or less, Mn: 2.0% or less, P: 0.030% or less, S: 0.030% or less, Cr: 27.0 to 31.0%, Fe: 7.0 to 11.0%, Ti: 0.5% or less, Cu: 0.50% or less, and Al: 2.00% or less, with the balance being Ni and impurity.

Since the aforementioned (a) alloy contains Cr at 14.0 to 17.0% and Ni at about 75%, it is an alloy excellent in corrosion resistance in environments containing chloride. For this alloy, from the viewpoint of the balance of Ni content and Cr content, the Fe content is preferably set to 6.0 to 10.0%.

Since the aforementioned (b) alloy contains Cr at 27.0 to 31.0% and Ni at about 60%, it is an alloy excellent in corrosion resistance of pure water and alkali environments at high temperatures as well as in environments containing chloride. For this alloy as well, from the viewpoint of the balance of Ni content and Cr content, the Fe content is preferably set to 7.0 to 11.0%.

6. How to Supply the Atmospheric Gas

FIG. 1 is a schematic diagram showing an embodiment of the method for producing a Cr containing nickel-base alloy tube according to the present invention. FIG. 1(a) shows an example of how the atmospheric gas is supplied when a preceding tube group 1a is undergoing heat treatment and a following tube group 1b is not yet heat treated. FIG. 1(b) shows an example of how the atmospheric gas is supplied when both preceding tube group 1a and following tube group 1b are undergoing heat treatment. FIG. 1(c) shows an example of how the atmospheric gas is supplied when the following tube group 1b is undergoing heat treatment. FIG. 2 is an enlarged plan view showing a gas feeding tube 3 and a header 2 in FIG. 1.

As shown in FIG. 1, a continuous heat treatment furnace (hereinafter simply called heat treatment furnace) 5 is provided with a heating zone 5a and a cooling zone 5b. The tube groups 1a and 1b are transferred to the right direction in the figure. The furnace atmosphere of this heat treatment furnace 5 is a hydrogen gas atmosphere. Further, the furnace pressure is set to be slightly higher than atmospheric pressure to prevent inflow of air.

At the outlet side of the heat treatment furnace 5 (right direction in the figure), for example, two gas supplying devices 4a and 4b are provided. The gas supplying devices 4a and 4b are movable in the same direction as the tube groups 1a and 1b. To avoid mutual interference, the illustrated gas supplying devices 4a and 4b are displaced relative to one another in the direction perpendicular to the paper.

As shown in the enlarged plan view of FIG. 2, the preceding tube group 1a and the following tube group 1b are all inserted on tapering nozzles 2a of the header 2. Alongside the header 2, a gas feeding tube 3 is provided. It is noted that the header 2 for the tube group 1a and the gas feeding tube 3 provided alongside it have no conduction therebetween. The gas feeding tube 3 is connected to the header 2 for the following tube group 1b and used for feeding the atmospheric gas into the following tube group 1b. That is, in this example, the atmospheric gas is supplied from the outlet side of the heat treatment furnace 5.

As shown in FIG. 1(a), to the preceding tube group 1a that is undergoing heat treatment, the atmospheric gas is supplied from the gas supplying device 4a, while to the following tube group 1b that is not yet heat treated, the atmospheric gas is supplied from the gas supplying device 4b through the gas feeding tube 3 provided alongside the header 2 of the preceding tube group 1a. In this time, the atmospheric gas is supplied in the tube from the front end toward the other end of the tube.

Next, as shown in FIG. 1(b), with the above state, the preceding tube group 1a and the following tube group 1b are transferred to the right direction in the figure and inserted in the heat treatment furnace 5.

After the front end of the following tube group 1b reaches the outlet side of the heating zone 5a of the heat treatment furnace 5, supply of the atmospheric gas is switched to supply from the other gas supplying device 4a. The operations from FIG. 1(b) to (c) are shown in (1) to (5) below.

(1) Connection between the header 2 of the preceding tube group 1a and the gas supplying device 4a is released.

(2) Connection between the gas feeding tube 3 of the preceding tube group 1a and the header 2 of the following tube group 1b is released.

(3) The gas supplying device 4a is directly connected to the header 2 of the following tube group 1b. That is, supply of the atmospheric gas to the following tube group 1b is switched from the gas supplying device 4b to the gas supplying device 4a.

(4) Connection between the Gas Feeding Tube 3 of the Preceding Tube Group 1a and the Gas Supplying Device 4b is released.

(5) The gas supplying device 4b is left on stand-by to wait for connection with the gas feeding tube 3 of the following tube group 1b in order to supply the atmospheric gas inside the tubes of the following tube group 1c (see FIG. 1(c)).

In the example shown in FIG. 1, at least two gas supplying devices are necessary, and three or more gas supplying devices may be used.

FIG. 3 is a schematic diagram showing another embodiment of the method for producing a Cr containing nickel-base alloy tube according to the present invention. FIG. 3(a) shows an example of how the atmospheric gas is supplied to the preceding tube group la before it is heat treated. FIG. 3(b) shows an example of how the atmospheric gas is supplied to the preceding tube group 1a when it is undergoing heat treatment. FIG. 3(c) shows an example of how the atmospheric gas is supplied to the preceding tube group 1a and the following tube group 1b when they are undergoing heat treatment. FIG. 4 is an enlarged plan view of the gas feeding tube 3 and the header 2 shown in FIG. 3. It is noted that the heat treatment furnace 5 shown in FIG. 3 is the same as that shown in FIG. 1.

In the example shown in FIG. 3, for example, the gas supplying devices 4a and 4b are respectively provided at the inlet side (left side of the figure) and outlet side (right side of the figure) of the heat treatment furnace 5. The tube groups 1a and 1b are transferred to the right direction in the figure. The gas supplying devices 4a and 4b are movable in the same direction as the tube groups 1a and 1b.

As shown in FIG. 4, the preceding tube group 1a and the following tube group 1b that are not yet heat treated are all inserted on tapering nozzles 2a of the header 2. The header 2 has, in the middle thereof in the longitudinal direction, a protruding part 2c that is provided with an openable and closable plug 2b at the right end of the protruding part 2c. The gas feeding tube 3 is inserted on a tapering nozzle 2a located in the middle of the header 2 in the longitudinal direction. The gas feeding tube 3 is supplied with the atmospheric gas from the inlet side of the heat treatment furnace 5. The gas feeding tube 3 is preferably provided with a check valve, not shown, that permits flow of the atmospheric gas only in the right direction in the figure.

As shown in FIG. 3(a), for example, the atmospheric gas is supplied to the tubes of the preceding tube group 1a when it is not heat treated from the gas supplying device (gas supplying device disposed at the inlet side of the heat treatment furnace) 4a through the gas feeding tube 3 and the header 2 closed by the plug 2b. In this case, the atmospheric gas is supplied from the front end toward the rear end of the tube group 1a.

As shown in FIG. 3(b), with the above state, the preceding tube group 1a is transferred to the right direction in the figure and inserted in the heat treatment furnace 5. Then, after the front end of the tube group 1a reaches the outlet side of the heating zone 5a of the heat treatment furnace 5, supply of the atmospheric gas is changed from the gas supplying device 4a at the inlet side to the gas supplying device 4b at the outlet side. The gas supplying device 4a at the inlet side is left on stand-by for supply of the atmospheric gas to the following tube group 1b. Here the plug 2b is in the open state.

As shown in FIG. 3(c), heat treatment is conducted simultaneously to the preceding tube group 1a to which the atmospheric gas is supplied from the gas supplying device 4b at the outlet side and the following tube group 1b to which the atmospheric gas is supplied from the gas supplying device 4a at the inlet side.

While in the example shown in FIG. 3 the gas supplying devices 4a and 4b are respectively provided at the inlet side and outlet side of the heat treatment furnace 5, this configuration is not intended to be limiting. That is, the following is a possible operation using one gas supplying device.

(a) After the front end of the tube group la reaches the outlet side of the heating zone 5a of the heat treatment furnace 5, supply of the atmospheric gas is discontinued.

(b) Connection between the gas supplying device and the gas feeding tube is released, and the plug 2b is opened.

(c) The same gas supplying device is reconnected to the protruding part 2c from the outlet side of the heat treatment furnace, and the atmospheric gas is supplied to the tube group 1a.

In this case, however, processability deteriorates because the tube groups need to be inserted in the heat treatment furnace on a one-by-one basis. Therefore, the configuration shown in FIG. 3, which uses gas supplying devices each at the inlet side and outlet side, is preferable.

Additionally, in the case where the length of the tube is extremely short, two or more tubes may be connected with a joint member in which the ends of the tubes are engaged in order to result in an increased length to constitute the tube group 1a (1b, 1c).

In the method embodied in the FIGS. 1 and 3, it will be readily appreciated that the set of the header 2 and the gas feeding tube 3 is used in a cyclic manner. The shape of the header 2 may be as shown in FIGS. 1 to 4, where the atmospheric gas from the gas supplying device is allowed to flow inside each of the tubes through a plurality of tubes that divaricate the atmospheric gas, or the header 2 may be in the shape of a BOX in order to supply gas to each tube at more uniform flow rate.

By allowing the atmospheric gas to flow inside the tube before being inserted in the heat treatment furnace in the manner described above, the air inside the tube is purged. Hence, during the heat treatment, a predetermined chromium oxide film is formed on the inner surface of the tube. Since the atmospheric gas is always supplied from the front end toward the rear end of the tube in the traveling direction, the gas flows inside the tube in the direction opposite the traveling direction of the tube in the heat treatment furnace as well. Thus, a residual substance on the inner surface of the tube after cleaning and before heat treatment is evaporated at a high temperature part of the heat treatment to be discharged outside the tube.

The evaporated residual substance on the inner surface of the tube travels along the gas flow in the tube and recondensates upon reaching a non-heating part to occasionally adhere again on the inner surface of the tube. However, the substance is evaporated again by a rise in temperature that follows to eventually be discharged altogether out of the tube. As a result, a uniform oxide film with desired performance is formed on the inner surface without conducting electrolytic polishing in advance such as for the EP tube.

7. Production Method of the Tube of the Cr Containing Nickel-Base Alloy

As a production method of the tube of the Cr containing nickel-base alloy related to the present invention, after a Cr containing nickel-base alloy of a predetermined chemical composition is melted to produce an ingot, the tube is usually produced in a hot working-annealing step or a hot working-cold working-annealing step. Further, to improve corrosion resistance of the base material, a special kind of heat treatment called TT treatment (Thermal Treatment) is occasionally conducted.

The heat treatment method of the present invention may be conducted after the above-described annealing, or conducted also as annealing. Conducting the heat treatment also as annealing saves on production costs because there is no need for a heat treatment step for forming the oxide film in addition to the conventional production steps. As described above, when TT treatment is conducted after annealing, it may be conducted also as the heat treatment for forming the oxide film. Moreover, both annealing and TT treatment may be intended as treatment for forming the oxide film.

### EXAMPLE 1

The tubes tested were each produced by the following production method. First, alloys of chemical compositions shown in Table 1 were melt in a vacuum and cast, and ingots were obtained. The ingots were hot-forged into billets, and the tubes were produced from the billets by the hot-extrusion method. These tubes were further worked into tubes for extrusion by cold rolling with the cold pilger mill. The tubes for extrusion have an outer diameter of 23.0 mm and a wall thickness of 1.4 mm. After being annealed in a hydrogen atmosphere at 1100° C., the tubes were worked into the final tubes in the cold extrusion process. Each of the tubes has a size with an outer diameter of 16.0 mm, a wall thickness of 1.0 mm, and a length of 18000 mm. The reduction ratio in cross section area was 50%. Then, the outside and inside surfaces of the respective tubes were washed by an alkaline degreasing liquid and rinsed by water. After that they were subjected to heat treatment tests of the respective conditions shown in Table 2.

TABLE 1

| | Chemical composition (mass %, with the balance being Ni and impurity) | | | | | | | | | | |
|---|---|---|---|---|---|---|---|---|---|---|---|
| Alloy | C | Si | Mn | P | S | Cr | Fe | Ti | Cu | Al | Others |
| A | 0.019 | 0.32 | 0.31 | 0.011 | 0.001 | 29.8 | 9.1 | 0.21 | 0.01 | 0.15 | — |
| B | 0.022 | 0.33 | 0.28 | 0.012 | 0.001 | 16.2 | 8.9 | 0.23 | 0.18 | 0.13 | — |
| C | 0.019 | 0.38 | 0.27 | 0.012 | 0.001 | 20.5 | 4.7 | 0.24 | 0.05 | 0.15 | Nb: 3.5 |
| D | 0.020 | 0.40 | 0.23 | 0.015 | 0.001 | 20.7 | 4.5 | 0.22 | 0.03 | 0.18 | Ta: 3.7 |
| E | 0.019 | 0.38 | 0.26 | 0.011 | 0.001 | 20.8 | 4.6 | 0.26 | 0.07 | 0.13 | Mo: 8.5 |

TABLE 2

| | | Heat treatment conditions | | | | | | | | |
|---|---|---|---|---|---|---|---|---|---|---|
| | | | | Concentration of atmospheric | | | | | | |
| | | | | gas (Vol. %) | | | | | | |
| | | | | | | | Non-oxidation | | | |
| | | Temp. | Time | Oxidation gas | | | gas | | Flow rate | |
| No | Alloy | (° C.) | (min) | CO₂ | H₂O | O₂ | H₂ | Ar | (L/min) | C × Q^{1/2} |
| 1 | A | 1100 | 5 | 0.6 | — | — | 99.4 | — | 33.3 | 3.4 |
| 2 | A | 1100 | 5 | 0.3 | — | — | 99.7 | — | 33.3 | 1.7 |
| 3 | A | 1100 | 5 | 0.1 | — | — | 99.9 | — | 33.3 | 0.6 |
| 4 | A | 1100 | 5 | 1.0 | — | — | 99.0 | — | 5.6 | 2.4 |
| 5 | A | 1100 | 5 | 0.1 | 0.9 | — | 99.0 | — | 5.6 | 2.4 |
| 6 | A | 1100 | 5 | 0.5 | — | 0.1 | — | 99.4 | 5.6 | 1.4 |
| 7 | A | 1100 | 5 | 0.5 | 0.9 | 0.1 | — | 98.5 | 5.6 | 3.5 |
| 8 | B | 1100 | 5 | 1.0 | — | — | 99.0 | — | 5.6 | 2.4 |
| 9 | C | 1100 | 5 | 1.0 | — | — | 99.0 | — | 5.6 | 2.4 |
| 10 | D | 1100 | 5 | 1.0 | — | — | 99.0 | — | 5.6 | 2.4 |
| 11 | E | 1100 | 5 | 1.0 | — | — | 99.0 | — | 5.6 | 2.4 |
| 12 | A | 1100 | 5 | — | 0.9 | — | 99.1 | — | 5.6 | 2.1 |
| 13 | A | 1100 | 5 | 0.1 | — | — | 99.9 | — | 5.6 | 0.2 |

C: Concentration of oxidation gas (vol %)
Q: Flow rate of atmospheric gas (l/min)

In Nos. 1 to 3, the chromium oxide film was formed by heating while supplying 33.3 l/min of atmospheric gas to the tube from the gas supplying device through the header. In Nos. 4 to 13, the tubes were connected to twenty-one nozzles provided on the header, and through the header, atmospheric gas was supplied to the tubes from the gas supplying device at an amount of 7 Nm³/h (5.6 l/min per one tube).

Both ends of the heat treated tube were cut out and examined for composition of the film by an EDX (Energy Dispersive X-ray micro-analyzer) to find the formation of an oxide film consisting of chromium oxide. A cross section was observed by SEM (Scanning Electron Microscope) to measure the thickness of the oxide film at both ends of the tube, thicknesses at respective tube ends were denoted as t1 and t2, and variation of both thicknesses was evaluated as |t1−t2|. Table 3 shows “⊚” for a variation of 0.30 μm or less, “◯” for a variation of more than 0.30 μm and 0.50 μm or less, and “×” for a variation of more than 0.50 μm.

The thickness of the oxide film was measured at both ends of each tube after the above heat treatment, and test pieces were sampled from the thinner end of the film and subjected to a release test. In the release test, using an autoclave, the amount of released Ni ion was measured in simulated water of the primary system of a pressurized water reactor. Here pollution of the test liquid by ions released from jigs and like was prevented by sealing the simulated water of the primary system of a pressurized water reactor on the inner surface of each test piece using a lock of Ti. At a test temperature of 320° C., the test pieces were each immersed in 500 ppm B+2 ppm Li+30 cc H₂/kg H₂O (STP), which was the simulated water of the primary system of a pressurized water reactor, for 1000 hours. Immediately after completion of the test, the solution was analyzed by the high-frequency inductively coupled plasma (ICP) method to examine the amount of the released Ni ions. Table 3 also shows there results. A release of 0.05 ppm or less is indicated as “⊚”, a release of more than 0.05 ppm and 0.30 ppm or less is indicated as “◯”, and a release of more than 0.30 ppm is indicated as “×”.

TABLE 3

| | Chromium oxide coating | | | | Evaluation | |
|---|---|---|---|---|---|---|
| | Tube end | Tube end | | The amount | | The |
| | thickness | thickness | | of Ni | Variation | amount |
| | t1 | t2 | \|t1 − t2\| | release | of coating | of Ni |
| No | (μm) | (μm) | (μm) | (ppm) | thickness | release. |
| 1 | 0.56 | 0.31 | 0.25 | 0.02 | ⊚ | ⊚ |
| 2 | 0.69 | 0.72 | 0.03 | 0.02 | ⊚ | ⊚ |
| 3 | 0.22 | 0.21 | 0.01 | 0.17 | ⊚ | ◯ |
| 4 | 0.66 | 0.48 | 0.18 | 0.03 | ⊚ | ⊚ |
| 5 | 0.72 | 0.28 | 0.44 | 0.06 | ◯ | ◯ |
| 6 | 0.76 | 0.33 | 0.43 | 0.03 | ◯ | ⊚ |
| 7 | 1.02 | 0.58 | 0.44 | 0.02 | ◯ | ⊚ |
| 8 | 0.57 | 0.25 | 0.32 | 0.07 | ◯ | ◯ |
| 9 | 0.73 | 0.28 | 0.45 | 0.06 | ◯ | ◯ |
| 10 | 0.70 | 0.30 | 0.40 | 0.02 | ◯ | ⊚ |
| 11 | 0.62 | 0.28 | 0.34 | 0.07 | ◯ | ◯ |
| 12 | 0.40 | 1.10 | 0.70 | 0.02 | X | ⊚ |
| 13 | 0.11 | 0.13 | 0.02 | 0.36 | ⊚ | X |

Table 3 shows that in the test pieces numbered 1 to 11, which were heat treated by methods satisfying the conditions specified by the present invention, the thickness of the chromium oxide film formed on the inner surface of each tube satisfies the range of the present invention, variation in thickness of the oxide film along the length of each tube is minimized, and the amount of Ni release is as small as 0.30 ppm or less.

In contrast, in the test piece numbered 12, in which only water vapor was used as oxidation gas, the variation in thickness of the oxide film along the length of the tube is large. Hence, there is a fear of occurrence of a part where the thickness of the oxide film is thin and thus the amount of Ni release increases. In the test piece numbered 13, where the relation between concentration of the oxidation gas and flow rate of the atmospheric gas was outside the range specified by the present invention although the atmospheric gas satisfied the condition specified by the present invention, the thickness of the oxide film is thin and the amount of Ni release exceeds 0.30 ppm.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

According to the present invention, a Cr containing nickel-base alloy tube having on its inner surface a chromium oxide film formed inexpensively and uniformly can be obtained. Since release of Ni is very little even used in high-temperature water such as in an nuclear power plant for a long period of time, it is most suitable as members used in high temperature water such as steam generator tubing, in particular, members for an nuclear power plant.

### BRIEF DESCRIPTION OF THE DRAWINGS

FIG. 1 is a schematic diagram showing embodiments of a method for producing a Cr containing nickel-base alloy tube according to the present invention. FIG. 1(a) shows an example of how the atmospheric gas is supplied when a preceding tube group 1a is undergoing heat treatment and a following tube group 1b is not yet heat treated. FIG. 1(b) shows an example of how the atmospheric gas is supplied when both preceding tube group 1a and following tube group 1b are undergoing heat treatment. FIG. 1(c) shows an example of how the atmospheric gas is supplied when the following tube group 1b is undergoing heat treatment.

FIG. 2 is an enlarged plan view showing a gas feeding tube 3 and a header 2 shown in FIG. 1.

FIG. 3 is a schematic diagram showing another embodiment of the method for producing a Cr containing nickel-base alloy tube according to the present invention. FIG. 3(a) shows an example of how the atmospheric gas is supplied to the preceding tube group la before it is heat treated. FIG. 3(b) shows an example of how the atmospheric gas is supplied to the preceding tube group 1a when it is undergoing heat treatment. FIG. 3(c) shows an example of how the atmospheric gas is supplied to the preceding tube group 1a and the following tube group 1b when they are undergoing heat treatment.

FIG. 4 is an enlarged plan view of the gas feeding tube 3 and the header 2 shown in FIG. 3.

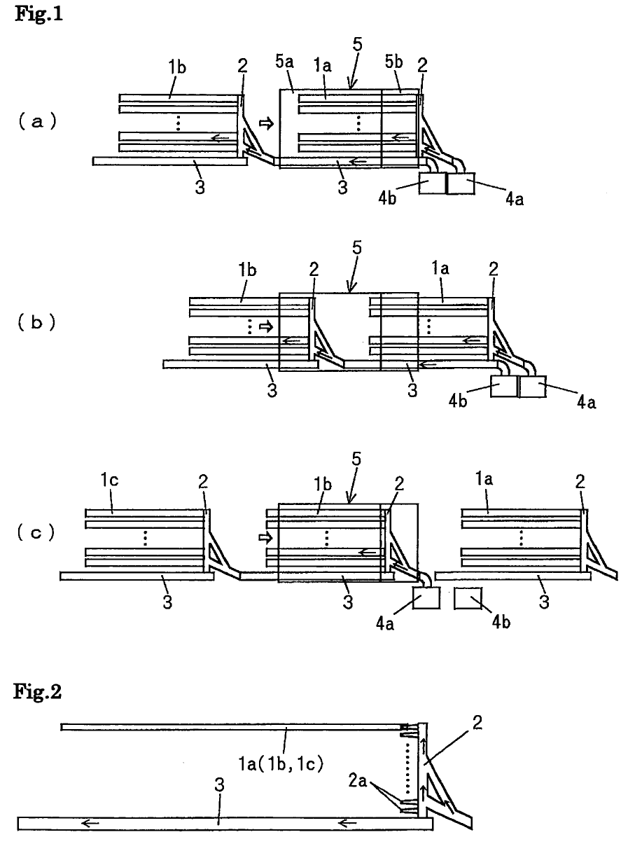

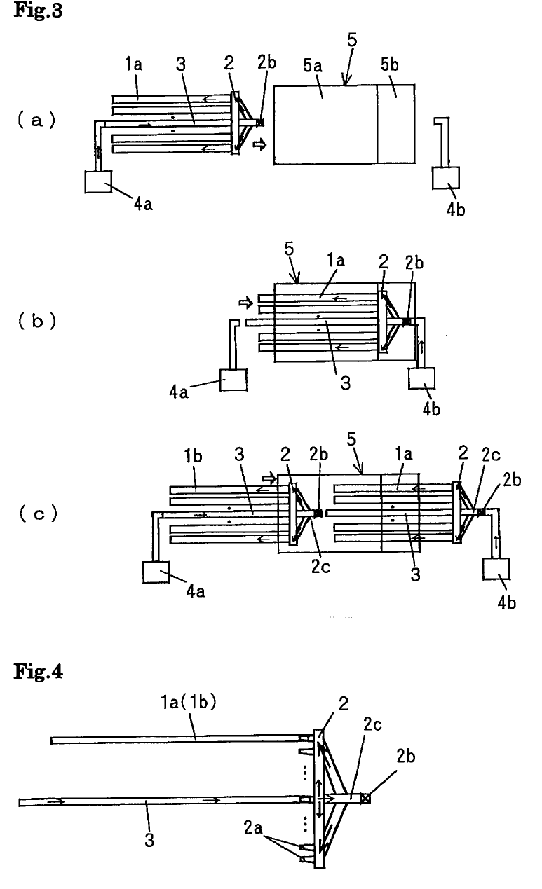

### DESCRIPTION OF THE REFERENCE NUMERALS

1a, 1b, 1c: Tube (Cr containing nickel-base alloy tube) group
2: Header
2a: Nozzle
2b: Plug
2c: Protruding part
3: Gas feeding tube
4a, 4b: Gas supplying device
5: Continuous heat treatment furnace
5a: Heating zone
5b: Cooling zone

1. A method for producing a Cr containing nickel-base alloy tube, characterized by forming an oxide film consisting of chromium oxide having a thickness of 0.2 to 1.5 μm on the inner surface of the Cr containing nickel-base alloy tube by heating the Cr containing nickel-base alloy tube in an atmospheric gas of carbon dioxide gas and non-oxidation gas.

2. The method for producing a Cr containing nickel-base alloy tube according to claim 1, characterized in that the atmospheric gas contains oxygen gas of 5 vol % or less and/or water vapor of 7.5 vol % or less.

3. The method for producing a Cr containing nickel-base alloy tube according to claim 1, characterized by controlling the concentration of the oxidation gas and the flow rate of the atmospheric gas into the Cr containing nickel-base alloy tube.

4. The method for producing a Cr containing nickel-base alloy tube according to claim 2, characterized by controlling the concentration of the oxidation gas and the flow rate of the atmospheric gas into the Cr containing nickel-base alloy tube.

5. The method for producing a Cr containing nickel-base alloy tube according to claim 3, characterized by feeding the atmospheric gas into the Cr containing nickel-base alloy tube while satisfying a relation specified by the following formula (1):
0.5≦C×Q^{1/2}≦7.0 (1)
where:
C denotes concentration of the oxidation gas (vol %); and
Q denotes flow rate of the atmospheric gas (l/minute).

6. The method for producing a Cr containing nickel-base alloy tube according to claim 4, characterized by feeding the atmospheric gas into the Cr containing nickel-base alloy tube while satisfying a relation specified by the following formula (1):
0.5≦C×Q^{1/2}≦7.0 (1)
where:
C denotes concentration of the oxidation gas (vol %); and
Q denotes flow rate of the atmospheric gas (l/minute).

7. The method for producing a Cr containing nickel-base alloy tube according to claim 1, characterized by forming a chromium oxide film, satisfying a relation specified by the following formula (2), on the inner surface of the Cr containing nickel-base alloy tube.

|t1−t2|≦0.5 μm (2)
where t1 and t2 denote thickness (μm) of the chromium oxide film at both ends of the tube.

8. The method for producing a Cr containing nickel-base alloy tube according to claim 3, characterized by forming a chromium oxide film, satisfying a relation specified by the following formula (2), on the inner surface of the Cr containing nickel-base alloy tube.

|t1−t2|≦0.5 μm (2)
where t1 and t2 denote thickness (μm) of the chromium oxide film at both ends of the tube.

9. The method for producing a Cr containing nickel-base alloy tube according to claim 5, characterized by forming a chromium oxide film, satisfying a relation specified by the following formula (2), on the inner surface of the Cr containing nickel-base alloy tube.

|t1−t2|≦0.5 μm (2)
where t1 and t2 denote thickness (μm) of the chromium oxide film at both ends of the tube.

10. The method for producing a Cr containing nickel-base alloy tube according to claim 1, characterized in that the Cr containing nickel-base alloy tube contains, by mass %, C: 0.15% or less, Si: 1.00% or less, Mn: 2.0% or less, P: 0.030% or less, S: 0.030% or less, Cr: 10.0 to 40.0%, Fe: 15.0% or less, Ti: 0.5% or less, Cu: 0.50% or less, and Al: 2.00% or less, with the balance being Ni and impurity.

11. The method for producing a Cr containing nickel-base alloy tube according to claim 5, characterized in that the Cr containing nickel-base alloy tube contains, by mass %, C: 0.15% or less, Si: 1.00% or less, Mn: 2.0% or less, P: 0.030% or less, S: 0.030% or less, Cr: 10.0 to 40.0%, Fe: 15.0% or less, Ti: 0.5% or less, Cu: 0.50% or less, and Al: 2.00% or less, with the balance being Ni and impurity.

12. The method for producing a Cr containing nickel-base alloy tube according to claim 7, characterized in that the Cr containing nickel-base alloy tube contains, by mass %, C: 0.15% or less, Si: 1.00% or less, Mn: 2.0% or less, P: 0.030% or less, S: 0.030% or less, Cr: 10.0 to 40.0%, Fe: 15.0% or less, Ti: 0.5% or less, Cu: 0.50% or less, and Al: 2.00% or less, with the balance being Ni and impurity.

13. The method for producing a Cr containing nickel-base alloy tube according to claim 10, characterized in that the Cr containing nickel-base alloy tube contains at least one element selected from the following groups:
group 1: Nb and/or Ta : 3.15 to 4.15% by mass in total; and
group 2: Mo : 8 to 10% by mass.

14. The method for producing a Cr containing nickel-base alloy tube according to claim 11, characterized in that the Cr containing nickel-base alloy tube contains at least one element selected from the following groups:
group 1: Nb and/or Ta : 3.15 to 4.15% by mass in total; and
group 2: Mo : 8 to 10% by mass.

15. The method for producing a Cr containing nickel-base alloy tube according to claim 12, characterized in that the Cr containing nickel-base alloy tube contains at least one element selected from the following groups:
group 1: Nb and/or Ta : 3.15 to 4.15% by mass in total; and
group 2: Mo: 8 to 10% by mass.

16. The method for producing a Cr containing nickel-base alloy tube according to claim 1, characterized in that the Cr containing nickel-base alloy tube is used as a member for an nuclear power plant.

17. The method for producing a Cr containing nickel-base alloy tube according to claim 5, characterized in that the Cr containing nickel-base alloy tube is used as a member for an nuclear power plant.

18. The method for producing a Cr containing nickel-base alloy tube according to claim 7, characterized in that the Cr containing nickel-base alloy tube is used as a member for an nuclear power plant.

19. The method for producing a Cr containing nickel-base alloy tube according to claim 10, characterized in that the Cr containing nickel-base alloy tube is used as a member for an nuclear power plant.

20. The method for producing a Cr containing nickel-base alloy tube according to claim 12, characterized in that the Cr containing nickel-base alloy tube is used as a member for an nuclear power plant.

21. The method for producing a Cr containing nickel-base alloy tube according to claim 1, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the outlet side of the furnace by the gas supplying device through the gas feeding tube;
(2) feeding the tube into the continuous heat treatment furnace while supplying the atmospheric gas from the front end of the tube toward the rear end thereof, and
(3) replacing the gas supplying device, after the front end of the tube reaches the outlet side of a heating zone of the continuous heat treatment furnace.

22. The method for producing a Cr containing nickel-base alloy tube according to claim 5, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the outlet side of the furnace by the gas supplying device through the gas feeding tube;
(2) feeding the tube into the continuous heat treatment furnace while supplying the atmospheric gas from the front end of the tube toward the rear end thereof, and
(3) replacing the gas supplying device, after the front end of the tube reaches the outlet side of a heating zone of the continuous heat treatment furnace.

23. The method for producing a Cr containing nickel-base alloy tube according to claim 10, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the outlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device, after the front end of the tube reaches the outlet side of a heating zone of the continuous heat treatment furnace.

24. The method for producing a Cr containing nickel-base alloy tube according to claim 11, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the outlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device, after the front end of the tube reaches the outlet side of a heating zone of the continuous heat treatment furnace.

25. The method for producing a Cr containing nickel-base alloy tube according to claim 1, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the inlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device from the outlet side of the furnace, after the front end of the tube reaches the outlet side of a heating zone of the continuous heat treatment furnace.

26. The method for producing a Cr containing nickel-base alloy tube according to claim 5, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the inlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device from the outlet side of the furnace, after the front end of the tube reaches the outlet side of a heating zone of the continuous heat treatment furnace.

27. The method for producing a Cr containing nickel-base alloy tube according to claim 10, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the inlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device from the outlet side of the furnace, after the front end of the tube reaches the outlet side of a heating zone of the continuous heat treatment furnace.

28. The method for producing a Cr containing nickel-base alloy tube according to claim 11, characterized by using a continuous heat treatment furnace, a gas feeding tube penetrating the furnace, and a gas supplying device movable in the tube feeding direction, and forming a chromium oxide film on the inner surface of the tube in the following steps:
(1) supplying an atmospheric gas from the front end of the tube toward the rear end thereof, before feeding the tube into the continuous heat treatment furnace, while the atmospheric gas is supplied from the inlet side of the furnace by the gas supplying device through the gas feeding tube;
(2) feeding the tube into the continuous heat treatment furnace while supplying the atmospheric gas from the front end of the tube toward the rear end thereof; and
(3) replacing the gas supplying device from the outlet side of the furnace, after the front end of the tube reaches the outlet side of a heating zone of the continuous heat treatment furnace.

29. A Cr containing nickel-base alloy tube, characterized by forming a chromium oxide film, having a thickness of 0.2 to 1.5 μm and satisfying a relation specified by the following formula (2), on the inner surface of the Cr containing nickel-base alloy tube.

|t1−t2|≦0.5 μm (2)
where t1 and t2 denote thickness (μm) of the chromium oxide film at both ends of the tube.

30. The Cr containing nickel-base alloy tube according to claim 29, characterized in that the Cr containing nickel-base alloy tube contains, by mass %, C: 0.15% or less, Si: 1.00% or less, Mn: 2.0% or less, P: 0.030% or less, S: 0.030% or less, Cr: 10.0 to 40.0%, Fe: 15.0% or less, Ti: 0.5% or less, Cu: 0.50% or less, and Al: 2.00% or less, with the balance being Ni and impurity.

31. The Cr containing nickel-base alloy tube according to claim 30, characterized in that the Cr containing nickel-base alloy tube contains at least one element selected from the following groups:
group 1: Nb and/or Ta: 3.15 to 4.15% by mass in total; and
group 2: Mo: 8 to 10% by mass.

32. The Cr containing nickel-base alloy tube according to claim 29, characterized in that the Cr containing nickel-base alloy tube is used as a member for an nuclear power plant.

33. The Cr containing nickel-base alloy tube according to claim 30, characterized in that the Cr containing nickel-base alloy tube is used as a member for an nuclear power plant.

34. The Cr containing nickel-base alloy tube according to claim 31, characterized in that the Cr containing nickel-base alloy tube is used as a member for an nuclear power plant.
